(19) United States
(12) Patent Application Publication
(10) Pub. No.: US 2009/0281898 A1
(43) Pub. Date: Nov. 12, 2009

(54) SYSTEM AND METHOD OF PROCESSING AFTERMARKET PURCHASE REQUESTS

(76) Inventor: DONALD J. MEIS, Oviedo, FL (US)

Correspondence Address: McKinney Law, LLC, 121 S. Orange Ave, Suite 1500, Orlando, FL, 32801, US

(21) Appl. No.: 12/118,450

(22) Filed: May 9, 2008

(51) Int. Cl. G06Q 30/00; G06F 3/048; G06F 17/30; G06Q 50/00; G06F 15/16; G06Q 99/00

(52) U.S. Cl. 705/14.51; 705/1; 715/764; 705/14.54; 705/26; 707/3; 709/206; 707/E17.044; 707/E17.014

(57) ABSTRACT

A system and method of processing aftermarket purchase requests is disclosed. Input is monitored using a memory resident program for a request to order a first OEM part and to determine whether the first OEM part is associated with at least one aftermarket part of a third party manufacturer. A notification is sent when at least one aftermarket part of a third party is associated with the first OEM part. The at least one aftermarket part of a third party is displayed and a link is provided to the third party aftermarket part manufacturer to order the at least one aftermarket part of the third party manufacturer.

### FIELD OF THE DISCLOSURE

The present disclosure is generally related to a system and method of processing aftermarket purchase requests.

### BACKGROUND

Replacing parts for automobiles, office equipment, computer equipment, and other consumer and commercial products, has become an industry within itself. Original equipment manufacturer (OEM) parts are known as those parts that are provided from the manufacturer of the product. Accordingly, replacement parts from the manufacturer are readily available, however, usually at a higher cost than parts from manufacturers other than the original equipment manufacturer. Alternative manufacturers have entered the replacement part market to compete with the original equipment manufacturers. Each OEM part has an identification number that is used to locate the appropriate replacement part. However, alternative manufacturers use different numbers that correspond to the OEM part number so that to identify all alternative manufacturers that have a suitable replacement part to that of the OEM part is time consuming and burdensome.

Hence, a shortcoming of the prior art is that there is no system that correlates OEM parts with acceptable replacements parts from other manufacturers other than the OEM. Accordingly, there is a need in the prior art for a system and method that eliminates the need for the purchaser to know or code all of the possible aftermarket parts to a particular manufacturer.

Another shortcoming in the prior art is that they fail to identify a variety of alternative manufacturers but are dependent on who placed the order. Accordingly, there is a need for a system and method that is installed on the purchaser's computer system that will identify predetermined part numbers regardless of who places the order.

There is also a need in the art for a system and method wherein the purchaser is able to either place the order for the replacement part from the OEM or code the part to the aftermarket vendor that has provided the application.

There is also a need in the art for a system and method that eliminates the need for the purchaser to manually cross reference parts.

There is also a need in the art for a system and method that provides a distinct marketing and sales advantage to anyone selling/purchasing aftermarket parts or services.

There is also a need in the art for a system and method to increase sales for any company that provides aftermarket parts, repairs, or products, in which they are in direct competition with the OEM or other aftermarket parts or service providers.

There is also a need in the art for a system and method that improves efficiencies in the sourcing of aftermarket parts.

It is, therefore, to the effective resolution of the aforementioned problems and shortcomings of the prior art that the present invention is directed.

However, in view of the prior art at the time the present invention was made, it was not obvious to those of ordinary skill in the pertinent art how the identified needs could be fulfilled.

### SUMMARY OF THE INVENTION

In a particular embodiment a system and method of processing aftermarket purchase requests is disclosed. Once installed, the present invention will actively monitor keyed input using a memory resident program, searching for specific strings of information. The string of information would typically be, but not limited to, a part number of a replaceable part, assembly, unit, or supply. Once the present invention recognizes the part number as a valid aftermarket item, the purchaser is notified that an alternate replacement part exists from a third party. The purchaser has the option to either continue placing the order with the OEM, or preferably, create a new order with the company that provides the aftermarket product. In most cases, aftermarket items are equally comparable and result in substantial cost savings to the purchaser, when used. Thus, lowering the cost of goods to the purchaser and boosting revenues of the aftermarket product provider.

The system and method uses a memory resident software application having data parsing and binary hashing capabilities to efficiently monitor keyed input with little or no noticeable effect on the performance of the purchaser's system. The memory resident software application (TSR) application runs behind the scenes without having to start or run another program. Once installed, the present invention will identify strings of information that match a predetermined data table. Once a data match has been established, a notification prompt or message will appear on the screen informing the purchaser that a suitable aftermarket part exists. The prompt is customizable to have whatever look and functionality desired.

For example, the prompt could be as simple as a small company logo with a link that displays somewhere on the screen. Alternatively, the prompt could have functionality built in to allow the purchaser to add the aftermarket part to a shopping cart or place the order immediately online with very few extra steps required.

The present invention can be downloaded by approved purchasers directly from an aftermarket manufacturer via a secure internet link. Alternatively, the present invention can be distributed to a manufacturer's customers in an electronic media format (e.g., CD ROM or flash memory).

Benefits of the present invention include increased sales to manufacturers of aftermarket parts, supplies or repairable items. Companies doing business with the manufacturer would also realize a greater cost savings over purchasing directly from the OEM. In addition, there is an increase in efficiency to the purchaser.

For example, the purchaser may not be aware that a replaceable part (e.g., hard disk drive) is available from a third party manufacturer. The purchaser continually places orders with the OEM for this part at a price of $375 each and its average monthly usage is 50 units. However, in accordance with the present invention, a purchaser orders the part number and a prompt notifies it that an acceptable replacement is available for $175 each. The purchaser now codes this part to the manufacturer that provided the software application for the present invention. The end result is that the purchaser realizes a true savings of $120,000 annually and the aftermarket manufacturer realizes increased revenues of $105,000 annually.

Any company that deals with the sales of aftermarket products can benefit from the present invention. In addition to business equipment parts distributors as illustrated above, other industries that could benefit from the present invention include, circuit board repair companies, business equipment supply distributors, aviation and aerospace parts distributors, pharmaceutical distributors, consumer electronic replaceable parts suppliers, telecommunications, automotive parts distributors and automotive repair centers.

It is therefore an object of the present invention to provide for an improvement that overcomes the aforementioned inadequacies of the prior art and provides a significant contribution to the advancement of processing aftermarket purchase requests.

Both the foregoing general description and the following detailed description are explanatory and are not restrictive of the invention as claimed. The accompanying drawings, which are incorporated in and constitute part of the specification, illustrate embodiments of the present invention and together with the general description, serve to explain principles of the present invention.

These and other important objects, advantages, and features of the invention will become clear as this description proceeds.

### BRIEF DESCRIPTION OF THE DRAWINGS

FIG. 1 is a partial flow diagram of a particular embodiment of a method of processing aftermarket purchase requests;

FIG. 2 is a continuation of the flow diagram of a method for processing aftermarket purchase requests shown in FIG. 1; and

FIG. 3 is a block diagram of a particular illustrative embodiment of a system for processing aftermarket purchase requests.

### DETAILED DESCRIPTION

As will be appreciated by one of skill in the art, embodiments of the present invention may be provided in various forms, including methods, systems, or computer program products. Accordingly, the present invention may take the form of an entirely hardware embodiment, an entirely software embodiment, or an embodiment combining software and hardware aspects. Furthermore, the present invention may take the form of a computer program product that is embodied on one or more computer-readable storage media (including, but not limited to, disk storage, CD-ROM, optical storage, and so forth) having computer-readable program code embodied therein.

The present invention is described with reference to flow diagrams and/or block diagrams of methods, apparatus (systems), and computer program products according to preferred embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flow diagram flow or flows and/or block diagram block or blocks.

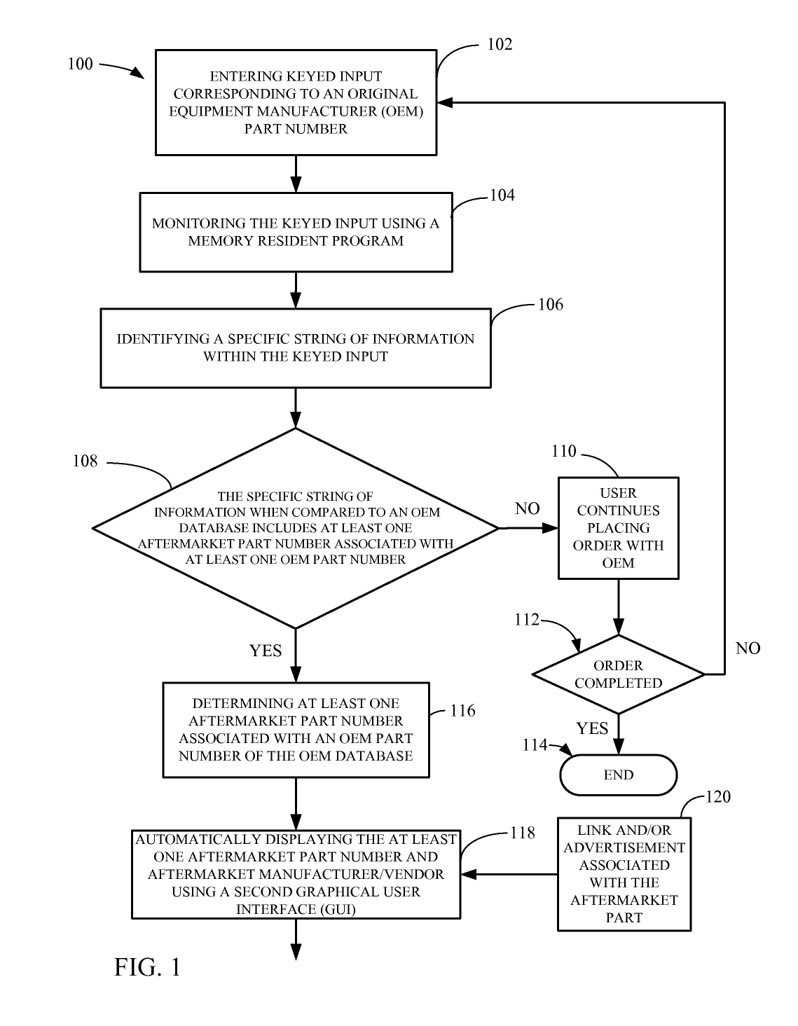

Referring to FIG. 1, a particular illustrative embodiment of a method for processing aftermarket purchase requests is disclosed and generally designated 100. A user enters a part number using a keyboard at 102 using a graphical user interface or any type of application (e.g., word processing). The keyed input is the OEM part number. In another particular embodiment, the keyed input is an aftermarket part number. The keyed input is monitored at 104 using a memory resident program that uses data parsing and binary hashing to detect a specific data string of information. The specific string of information is identified at 106 for comparing to a database of OEM numbers associated with third party aftermarket numbers at 108. The database can be stored locally or remotely for accessing. In addition, the database is adapatable to be updated in real-time to add and remove aftermarket and OEM part numbers. If a match is detected, then at 116 at least one third party aftermarket part number associated with an OEM part number is determined. If a match is not detected at 116, then the user continues placing the order for an OEM part at 110. If the user has no more parts to order then the order is completed at 114. If the order is not completed at 112, then the user returns to 102 to key in another part number. An electronic shopping cart is used to track a user's order.

In operation, once it is determined that at least one aftermarket part number of a third party is associated with an OEM part number at 116, the aftermarket part number is automatically displayed using a second graphical user interface at 118. A link and/or advertisement associated with the aftermarket part is provided at 120 so the user can decide whether to order the aftermarket part or order the OEM part. The advertisement can display relevant discounts or other qualities and features of the aftermarket part. In a particular embodiment, the Internet is used to establish communication with the aftermarket manufacturer and/or vendor when a match is determined.

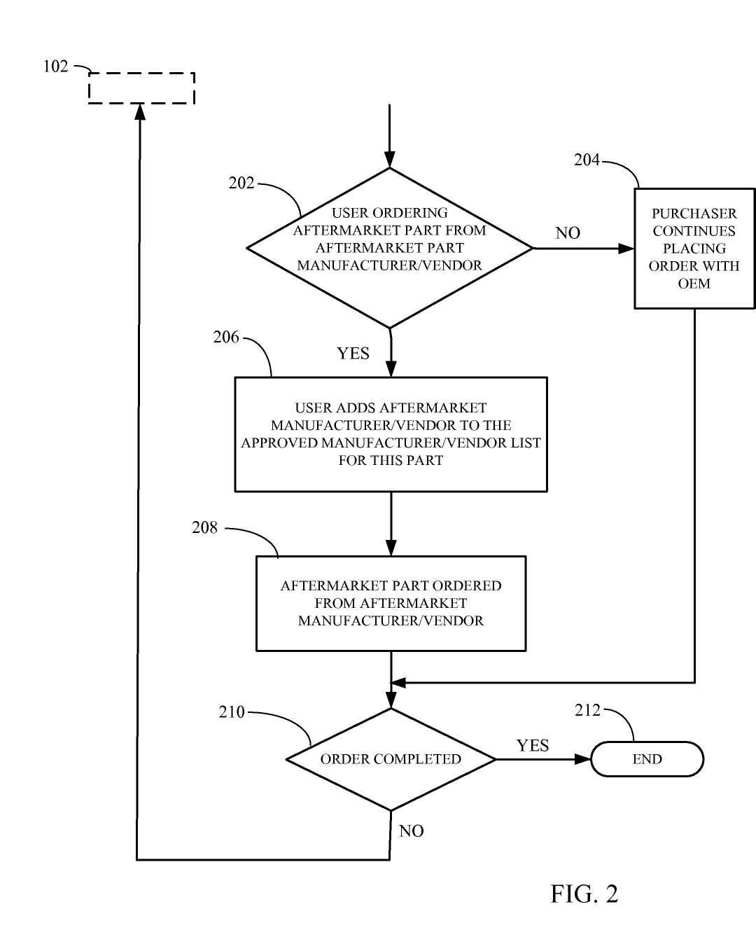

Referring now to FIG. 2, which is a continuation of the flow diagram of FIG. 1, a user decides whether to order the aftermarket part at 202. If the user decides not to order the aftermarket part, the user continues to place its order at 204 with the OEM. If the user decides to order the aftermarket part, then at 206 the aftermarket manufacturer and/or vendor is added to the approved manufacturer's list for the part and the aftermarket part is ordered at 208 from the aftermarket manufacturer and/or vendor. If the user has no more parts to order at 210 then the order is completed at 212. If the order is not completed at 210, then the user returns to 102 to key in another part number.

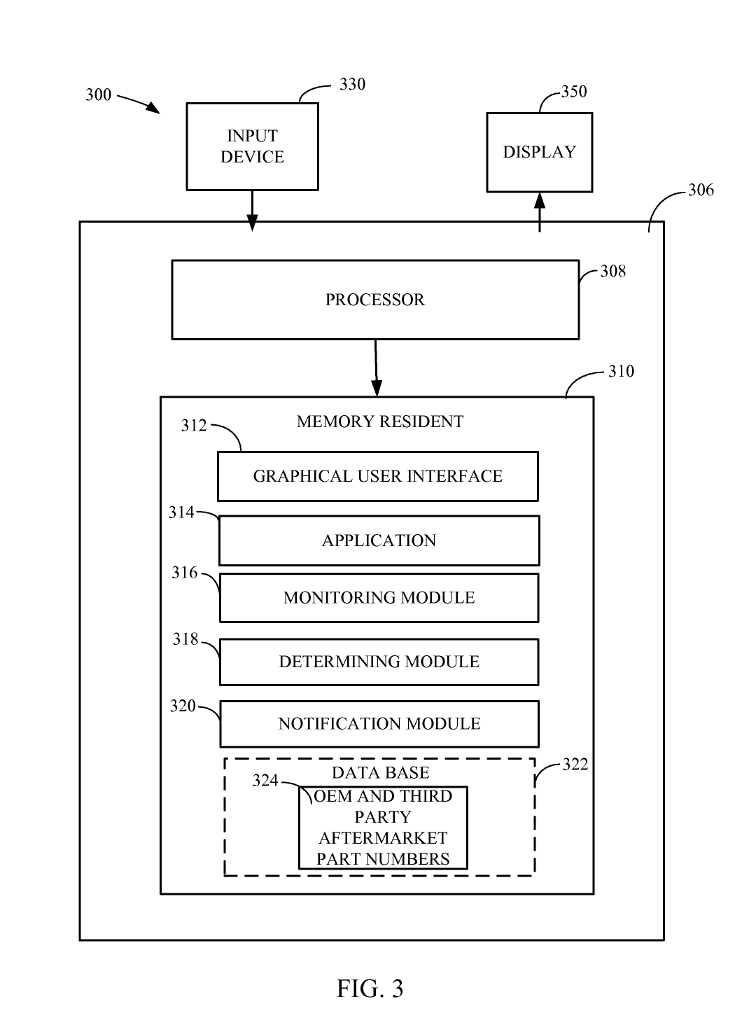

A block diagram of a particular embodiment of a system for processing aftermarket purchase requests is disclosed in FIG. 3 and generally designated 300. In a particular embodiment, the system 300 may be configured to perform the methods depicted in FIGS. 1 and 2. In a networked deployment, the system 300 illustrated in FIG. 3 may operate in the capacity of a server, such as a video server or application server, or a media device. The system 300 can also be implemented as or incorporated into various devices, such as a personal computer (PC), a tablet PC, a media device (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the system 300 can be implemented using electronic devices that provide voice, video or data communication. Further, while a single system 300 is illustrated, the term “system” shall also be taken to include any collection of systems or sub-systems that individually or jointly execute a set, or multiple sets, of instructions to perform one or more computer functions.

The system includes a device 306 having at least one processor 308 and a memory 310 that is accessible to the processor 308. The memory 310 includes media that is readable by the processor 308 and stores data and program instructions of software modules that are executable by the processor 308, including a GUI 312 and application 314 for entering part numbers, a monitoring module for monitoring the keyed input 316, a determining module for determining when an OEM part number matches an aftermarket part number 318, a notification module for notifying the user that an aftermarket part is available 320, and a database 322 that includes OEM and aftermarket part numbers 324. The memory 310 and the processor 308 also may include computer-readable media. In a particular embodiment, a memory resident program is used in part to implement system 300.

As shown, the system 300 may further include a video display unit 350, such as a liquid crystal display (LCD), an organic light emitting diode (OLED), a flat panel display, a solid-state display, or a cathode ray tube (CRT). Additionally, the computer 300 may include an input device 330, such as a keyboard, and a cursor control device, such as a mouse. The computer system 300 can also include a disk drive unit, a signal generation device, such as a speaker or remote control, and a network interface device.

In a particular embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of processing aftermarket purchase requests, the method comprising:
entering keyed input corresponding to an original equipment manufacturer (OEM) part number;
monitoring the keyed input;
identifying a specific string of information within the keyed input;
comparing the specific string of information to an OEM database, wherein the OEM database includes at least one third party aftermarket part number associated with at least one OEM part number;
determining at least one aftermarket part number of a third party associated with an OEM part number of the OEM database; and
automatically displaying the at least one aftermarket part number of a third party.

2. The method of claim 1, further comprising using data parsing and binary hashing to monitor the keyed input.

3. The method of claim 2, wherein the aftermarket part number is associated with at least one aftermarket part.

4. The method of claim 3, further comprising displaying a promotional advertisement, the promotional advertisement including a link to purchase the at least one aftermarket part from the at least one manufacturer.

5. The method of claim 4, wherein the promotional advertisement includes an image of the aftermarket part.

6. The method of claim 4, wherein the promotional advertisement is determined based on a user input.

7. The method of claim 1, wherein monitoring the keyed input using a memory resident program.

8. A method of processing aftermarket purchase requests, the method comprising:
monitoring input for a request to order a first OEM part;
automatically determining whether the first OEM part is associated with at least one aftermarket part of a third party;
sending a notification when at least one aftermarket part of a third party is associated with the first OEM part;
displaying the at least one aftermarket part after determining that the first OEM part is associated with the at least one aftermarket part of a third party; and
providing a first link to order the at least one aftermarket part of a third party.

9. The method of claim 8, wherein the first link is stored prior to monitoring input for a request to order a second OEM part.

10. The method of claim 8, further comprising sending an advertisement associated with each aftermarket part of a third party associated with the first OEM part.

11. The method of claim 10, wherein the advertisement includes a promotional recording promoting at least one aftermarket part of a third party.

12. The method of claim 11, wherein a database stores the promotional recording associated with an aftermarket part of a third party.

13. The method of claim 9, wherein monitoring the keyed input using a memory resident program.

14. The method of claim 8, wherein OEM part is for a piece of office equipment.

15. A computer-readable storage medium, comprising:
operational instructions, that when executed by a processor, cause the processor to monitor input for a request to order a first OEM part;
operational instructions, that when executed by the processor, cause the processor to automatically determine whether the first OEM part is associated with at least one aftermarket part of a third party;
operational instructions, that when executed by the processor, cause the processor to send a notification when at least one aftermarket part of a third party is associated with the first OEM part;
operational instructions, that when executed by the processor, cause the processor to display the at least one aftermarket part after determining that the first OEM part is associated with the at least one aftermarket part of a third party; and
operational instructions, that when executed by the processor, cause the processor to provide a first link using the second GUI to order the at least one aftermarket part of a third party.

16. The computer-readable storage medium of claim 15, wherein the operations instructions stay resident in memory.

17. A system, comprising:
a first interface to receive a request from a user to order an OEM part; and
a monitoring module to determine whether the request is associated with at least one aftermarket part of a third party and to generate a message to the user using a second interface after determining that the request is associated with at least one aftermarket part of a third party.

18. The system of claim 17, wherein the message identifies at least one aftermarket part of a third party.

19. The system of claim 18, wherein the message includes an advertisement associated with the at least one aftermarket part of a third party.

20. The system of claim 19, wherein the message includes a link to order the at least one aftermarket part of a third party.
